(19) United States
(12) Patent Application Publication
(10) Pub. No.: US 2008/0018283 A1
(43) Pub. Date: Jan. 24, 2008

(54) DRIVE ARRANGEMENT FOR MOTORIZED POSITIONING OF A FUNCTIONAL ELEMENT IN A MOTOR VEHICLE

(75) Inventors: Checrallah KACHOUH, Dortmund (DE); Ivica STANIC, Dormagen (DE); Slawomir KOTYRBA, Wuppertal (DE)

Correspondence Address: ROBERTS, MLOTKOWSKI & HOBBES, P. O. BOX 10064, MCLEAN, VA, 22102-8064, US

(73) Assignee: BROSE SCHLIESSSYSTEME GMBH & CO. KG, Wuppertal (DE)

(21) Appl. No.: 11/776,861

(22) Filed: Jul. 12, 2007

Related U.S. Application Data
(63) Continuation-in-part of application No. PCT/EP06/00221, filed on Jan. 12, 2006.

(30) Foreign Application Priority Data
Jan. 12, 2005 (DE) 20 2005 000 462.6

(51) Int. Cl. H02P 1/04

(52) U.S. Cl. 318/466

(57) ABSTRACT

A drive arrangement for the motorized movement of a functional element in a motor vehicle. An electric drive motor moves the functional element in two directions via a first drive train and a second drive train. The drive force is transmitted simultaneously via the two drive trains in at least one of the two directions of movement of the functional element. One of the two drive trains comprises cable-operated speed transforming transmission with a drive cable which is used to transmit drive force while the other of the two drive trains is a cableless drive train. A differential with two outputs can optionally be connected downstream from the drive motor with the drive trains then extending from the outputs of the differential.

### CROSS-REFERENCE TO RELATED APPLICATIONS

This application is a continuation-in-part of International Application No. PCT/EP2006/000221.

### BACKGROUND OF THE INVENTION

1. Field of the Invention

This invention relates to a drive arrangement for motorized positioning of a functional element in a motor vehicle having a drive motor by which the functional element can be moved by a motor in two positioning directions, the drive motor being coupled via a first drive train and a second drive train to the functional element and the driving force being transmitted at the same time via both drive trains in the motorized movement of the functional element in at least one positioning direction.

2. Description of Related Art

The concept “drive arrangement” should be understood comprehensively here. The scope of application of the functional element under consideration comprises all areas of a motor vehicle in which there is motorized positioning of a functional element. Accordingly, the aforementioned functional element can be a tailgate, hood or cargo space hatch which can be positioned by a motor, as well as the trunk lid of a motor vehicle which can be positioning by a motor. Other examples of a functional element are all types of side doors which can be positioned by a motor, especially sliding doors which can be positioned by a motor. Other functional elements are convertible roofs, large-area roof windows or the like which can be positioned by a motor. Primarily the area of a tailgate of a motor vehicle which can be positioned by a motor is treated below, but should not be understood as limiting.

The known drive arrangement (U.S. Pat. No. 5,531,498) underlying the invention is used for motorized positioning of the “tailgate” in a motor vehicle as the functional element. The drive arrangement has a drive motor by which the tailgate can be moved by a motor in two positioning directions, therefore in the opening direction and in the closing direction. The tailgate here is equipped with two gas compression springs which cause pretensioning of the gate in the opening direction. In this way, a driving force or driving torque can be applied by the drive motor only in the closing direction of the tailgate. In the motorized opening process, it is therefore such that a braking function accrues to the drive motor in any case.

The drive motor is coupled by drive engineering via two drive trains to the tailgate, the driving force or driving torque being transmitted fundamentally at the same time via the two drive trains. Both drive trains act laterally on the tailgate; this counteracts the twisting of the tailgate in its motorized positioning. The drive motor is located essentially centrally on the tailgate, the two drive trains each having a cable-operated speed transforming transmission with a driving cable for transmission of the driving force. This cable-operated speed transforming transmission has advantages especially with respect to noise development in motorized positioning. In any case, durability is limited by the ageing phenomena which are to be expected, especially by unwanted stretching of the drive cable, by which operating reliability is reduced overall. Furthermore, the mechanical structure is comparatively complex.

### SUMMARY OF THE INVENTION

The object of the invention is to embody and develop the known drive arrangement such that the operating reliability is increased and the mechanical structure is simplified.

The aforementioned object is achieved in a drive arrangement of the initially mentioned type wherein only one of the two drive trains has a cable-operated speed transforming transmission for transmission of the driving force and that the other drive train is made without a cable.

What is important, first of all, is the finding that special advantages are obtainable when the two drive trains are of mechanically different types. In particular, it is provided that only one of the two drive trains has a cable-operated speed transforming transmission for transmission of the driving force and that the correspondingly other drive train is made without a cable. Thus, the drive train without the cable can be made exclusively with transmission elements, such as, for example, levers, gear wheels, connecting rods or the like, so that, in any case, this drive train has especially high durability. The correspondingly other drive train can then be made completely or partially as a cable-operated speed transforming transmission.

In one embodiment, the two drive trains each have kinematic couplings which ensure coupling of the respective drive train to the functional element to be positioned. The two kinematic couplings are made essentially identical in an especially preferred embodiment.

The approach in accordance with the invention can be applied especially advantageously to the hatch of a motor vehicle. The term “hatch” comprises all types of the aforementioned gates and covers of a motor vehicle. The use of the term “hatch” should not be interpreted in a restrictive manner.

An optimum arrangement is achieved by an embodiment in which the two kinematic couplings are located on opposite sides of the hatch, the drive motor being located in the immediate vicinity of the kinematic coupling. Drive-engineering “supply” of the second kinematic coupling takes place accordingly via the cable-operated speed transforming transmission of the second drive train.

A further increase of operating reliability is obtained by a clutch being connected between the drive motor and the drive trains, the clutch having a planetary gear which has a sun wheel, ring gear or planet carrier which can be braked for engagement via a brake. Additionally, tolerances which arise for example from stretching of the drive cable can be easily balanced by a spring-loaded tension roller.

In all drive arrangements with a single drive motor which is coupled by drive engineering via two drive trains to the functional element, unilateral tolerances, stretching, deformations and the like generally lead to unwanted changing of the division of the drive force between the two drive trains. In the hatch of the motor vehicle, this inevitably leads to twisting of the hatch. In the extreme case, this limits the operating reliability.

What is important here is the fact that, between the drive motor and the two drive trains, a differential is connected such that, for unilateral tolerances, a uniform power distribution between the two drive trains is ensured. This approach can be used for all conceivable embodiments of the two drive trains, regardless of whether, as described above, a cable-operated speed transforming transmission is used or not.

Other advantages, features, properties and aspects of this invention will become apparent from the following description with reference to the accompany the drawings.

### BRIEF DESCRIPTION OF THE DRAWINGS

FIG. 1 is a side view of the rear of a motor vehicle with a drive arrangement in accordance with the invention with the hatch opened,

FIG. 2 is a schematic top view of the drive arrangement shown in FIG. 1 in a position occurring with the hatch closed,

FIG. 3 is a view corresponding to that of FIG. 2 but showing another embodiment of the drive arrangement in accordance with the invention,

FIG. 4 a diagrammatic representation of the drive arrangement in accordance with another embodiment of the invention in a top view,

FIG. 5 shows another drive arrangement in accordance with the invention for the hatch of the motor vehicle as shown in FIG. 1 in a top view,

FIG. 6 is a top view of another drive arrangement in accordance with the invention for the hatch of the motor vehicle as shown in FIG. 1, and

FIG. 7 shows cable-operated speed transforming transmission with a cable tensioning device.

### DETAILED DESCRIPTION OF THE INVENTION

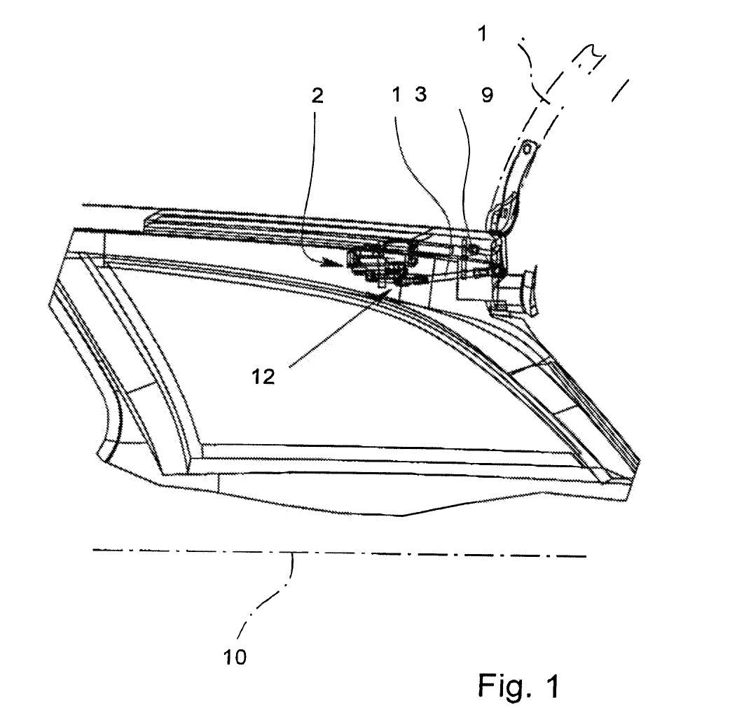

The preferred embodiments shown in FIGS. 1 to 7 relate to the motorized positioning of the functional element “tailgate” in a motor vehicle. It should not be interpreted in a restrictive manner. First of all, a few statements relating to the functional element 1 in general will be given below.

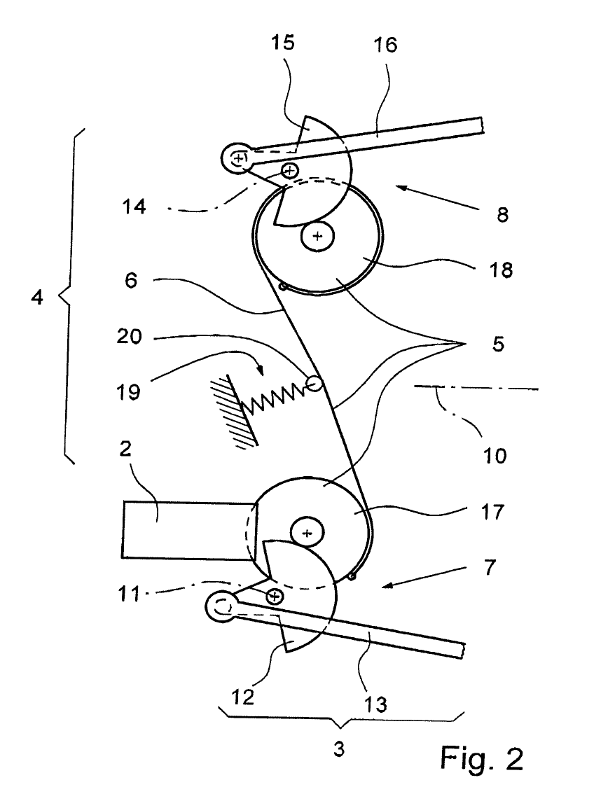

The motor vehicle shown only in part in FIG. 1 shows a drive arrangement for motorized positioning of one functional element 1, here the hatch 1 in a motor vehicle. There is a drive motor 2 by which the functional element 1 can be moved by a motor in two positioning directions, here in the opening direction and in the closing direction. The drive motor 2 is coupled by drive engineering to the functional element 1 via a first drive train 3 and a second drive train 4 (FIG. 2). This means that the driving force or driving torque proceeding from the drive motor 2 is routed via two chains of action of force to the functional element 1, the force being delivered on the functional element 1 accordingly at different points. Here, depending on the application, it can also be that the chains of action of force are identical in sections.

The driving force is transmitted in the motorized movement of the functional element 1 at least in one positioning direction at the same time via the two drive trains 3, 4. In the embodiment shown in FIGS. 1 & 2, this is the case for motorized positioning of the functional element 1 in the opening direction.

FIG. 2 shows that one of the two drive trains 3, 4 has a cable-operated speed transforming transmission 5 with a driving cable 6 for transmission of the driving force. It is important that only the second drive train 4 has a cable-operated speed transforming transmission 5 for transmission of the driving force and that the first drive train 3 is made without a cable. The advantages associated were explained above.

In an especially preferred configuration, a driving force for positioning of the functional element 1 can be transmitted in two directions via the first drive train 3. This is, for example, the case when the first drive train 3 has exclusively gearwheel speed transforming transmissions, worm-pinion speed transforming transmissions or the like. This is shown in FIG. 2. In addition, it is preferably provided that a driving force for positioning of the functional element 1 can be transmitted in only one direction via the second drive train 4. This is, for example, the case in a simple cable-operated speed transforming transmission 5, as likewise shown in FIG. 2. In this connection, the driving force in the motorized movement of the functional element 1 in one positioning direction is transmitted at the same time via the two drive trains 3, 4 and for the motorized movement of the functional element 1 in the other positioning direction solely via the first drive train 3.

In another preferred embodiment, the first drive train 3 has a first kinematic coupling 7 and the second drive train 4 has a second kinematic coupling 8, the two kinematic couplings 7, 8 ensuring the coupling of the respective drive train 3, 4 to the functional element 1 via drive engineering. For the preferred embodiment shown in FIG. 2, the two kinematic couplings 7, 8 are made essentially identical as connecting rod, speed transforming transmissions.

In the embodiment shown in FIG. 2, it is also such that the second kinematic coupling 8, therefore the connecting rod, speed transforming transmission 8, is coupled to the drive motor 2 via the cable-operated speed transforming transmission 5. The drive motor 2 is therefore coupled to the first kinematic coupling 7 without an interposed cable-operated speed transforming transmission 5 and to the second kinematic coupling 8 with an interposed cable-operated speed transforming transmission 5.

In one especially preferred configuration, the drive motor 2 is located in the immediate vicinity of the first kinematic coupling 7. Here, the two kinematic couplings 7, 8, as shown in FIG. 2, are located preferably spaced apart from one another, the distance being bridged in terms of drive engineering essentially by the cable-operated speed transforming transmission 5.

In the above described drive arrangement shown in FIG. 2, the drive motor 2 together with the first kinematic coupling 7, to a certain extent, forms an independent drive unit which is “expanded” via the cable-operated speed transforming transmission 5 by the second kinematic coupling 8. In this way, force can be easily delivered at different points of the functional element 1 in order to counteract twisting, tilting or the like of the functional element 1. One especially simple implementation arises when the bridging by the cable-operated speed transforming transmission 5 runs over an essentially straight segment. Then, deflection of the drive cable 6 is not necessary; this minimizes wear.

The aforementioned delivery of force via two drive trains 3, 4 is especially advantageous for the hatch 1 of a motor vehicle. As is shown in FIG. 1, the hatch 1 is pivotally coupled to the body of the motor vehicle, by which the hatch opening of the body can be closed. In the motorized positioning of the hatch 1 by means of the drive motor 2 between an open position and a closed position, twisting of the hatch 1 would have to be expected if the drive motor 2, as described above, does not act at two suitable, different points on the hatch 1.

It is pointed out that, in the embodiment shown in FIG. 1, the hatch 1 is coupled to the body of the motor vehicle to be able to pivot around the hatch axis 9. However, it can also provided that the pivoting capacity of the hatch 1 is implemented by a kinematic four-bar mechanism or the like. Furthermore, the hatch can be equipped with yokes, deflection levers or the like on which the two drive trains 3, 4 then possibly act.

Especially against the background of the danger of twisting of the hatch 1, it is preferably provided that the two kinematic couplings 7, 8 are coupled essentially symmetrically to the hatch 1 in terms of drive engineering. In this connection, it is preferably such that the two kinematic couplings 7, 8 act on the hatch 1 on its respective opposite sides and are, accordingly, located laterally. In the preferred embodiment shown in FIG. 2, as described above, there is a drive motor 2 in the immediate vicinity of the first kinematic coupling 7. The indication “lateral arrangement” here means that the pertinent component is located at some distance from the longitudinal center axis 10 of the motor vehicle. The arrangement on “opposite sides” is also referenced to the longitudinal center axis 10 of the motor vehicle.

In the above described preferred configuration, the drive motor 2, together with the first kinematic coupling 7, is located on one side and the second kinematic coupling 8 is accordingly located on the opposite side. Here, it is provided, for example, that the cable-operated speed transforming transmission 5 bridges the region of the rear roof frame or the like over a straight segment. As described above, deflection of the drive cable 6 can be eliminated.

It has already been pointed out that the kinematic couplings 7, 8 are each made as a connecting rod, speed transforming transmission. For this purpose, first of all, the first kinematic coupling 7 has a first positioning element 12 which can be pivoted around a first positioning element axis 11 and a first connecting rod 13. Accordingly, the second kinematic coupling 8 is equipped with a second positioning element 15 which can be pivoted around a second positioning element axis 14 and with a second connecting rod 16. Both connecting rods 13, 16 are, on the one hand, coupled eccentrically with regard to the respective positioning element axis 11, 14 relative to the respective positioning element 12, 15, and on the other hand, relative to the hatch 1. As explained above, the two kinematic couplings 7, 8 are made essentially identical and are arranged in mirror image here.

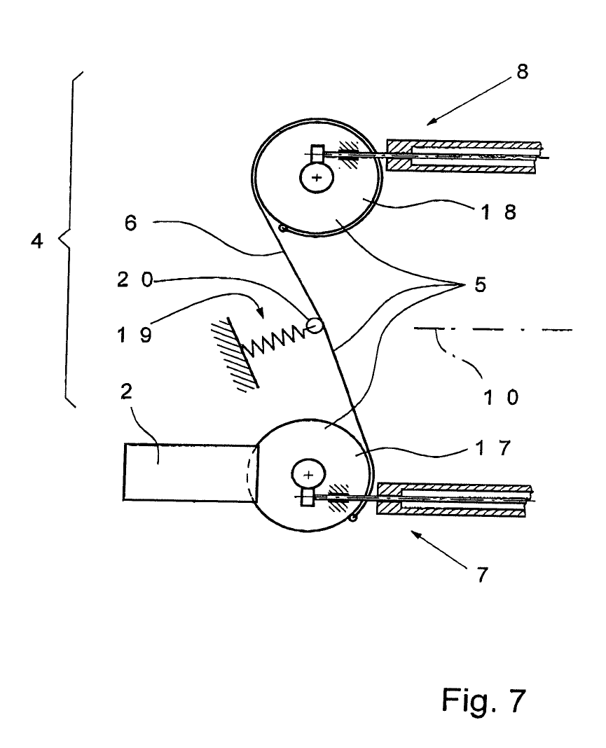

It should be pointed out that, for implementation of the two kinematic couplings 7, 8, numerous versions are conceivable. For example, as shown in FIG. 7, the first kinematic coupling 7 can comprise a first geared spindle drive and the second kinematic coupling 8 comprise a second geared spindle drive, the two geared spindle drives acting by drive engineering, on the one hand, on the body of the motor vehicle, and on the other hand, on the hatch.

A series of versions is also possible for implementation of the cable-operated speed transforming transmission 5. In a preferred embodiment, the cable-operated speed transforming transmission 5 has a first cable roller 17 and a second cable roller 18, and the drive cable 6 for drive-engineered coupling of the two cable rollers 17, 18 can be taken up onto the two cable rollers 17, 18. In this connection, preferably the first cable roller 17 is coupled to the first kinematic coupling 7 and the second cable roller 18 is coupled by drive engineering to the second kinematic coupling 8.

In the preferred embodiment shown in FIG. 2, the arrangement is such that take-up of the drive cable 6 on one cable roller 17, 18 causes unwinding of the drive cable 6 on the other cable roller 18, 17. In this implementation of the cable-operated speed transforming transmission 5, the drive force for positioning of the hatch 1 can be transmitted in only one direction via the second drive train 4. This version has already been addressed in conjunction with the general explanations relating to the functional element 1.

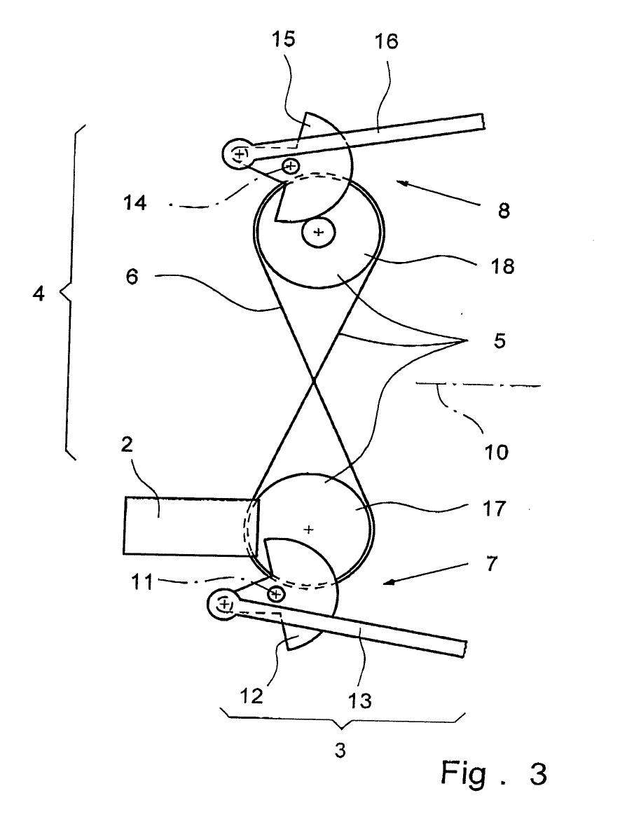

In certain applications, it can be advantageous for the drive cable 6 to be made as a closed loop which loops the two cable rollers 17, 18. This is shown in FIG. 3. In this further preferred embodiment, the driving force for positioning the hatch 1 in two directions can be transmitted via the second drive train 4.

In the preferred embodiments shown in FIGS. 2, 3, the drive motor is coupled by drive engineering to the first cable roller 17. This coupling is preferably a worm-gearwheel coupling. Fundamentally, the drive motor 2 can also be coupled to the positioning element 12 of the connecting rod-speed transforming transmission or another component. This depends essentially on the respective conditions of installation space.

In conjunction with the configuration of the cable-operated speed transforming transmission 5, it was pointed out above that, in the embodiment shown in FIG. 2, transmission of the driving force via the second drive train 4 for positioning of the hatch 1 in only one direction is possible. In this embodiment, in the motorized movement of the hatch 1 into the open position, the driving force is transmitted over the positioning region via the two drive trains 3, 4, while in the motorized positioning of the hatch 1 into the closed position, the driving force is transmitted the positioning region solely via the first drive train 3. In the illustrated embodiment, this is advantageous since the driving force necessary for moving of the hatch 1 into the open position is especially high.

Depending on the hatch arrangement, however, it can also be such that the driving force necessary for positioning the hatch 1 in the closed position is especially high. Then, it is preferably provided that, in the motorized movement of the hatch 1 into the closed position, the driving force is transmitted over the positioning region via the two drive trains 3, 4 and that in the motorized movement of the hatch 1 into the open position, the driving force is transmitted over the positioning region solely via the first drive train 3.

Depending on the configuration of the cable-operated speed transforming transmission 5, adaptation of the effective drive cable length is necessary. For this purpose, it is preferably provided that the effective drive cable length can be set by a correspondingly adjustable attachment of the drive cable 6. There can be a clamp or screw attachment for this purpose.

In the above addressed cable-operated speed transforming transmission, stretching of the drive cable 6 cannot fundamentally be precluded. Therefore, in a preferred configuration, there is a cable tensioning device 19 which applies a force to the drive cable 6 perpendicular its the lengthwise extension at an engagement point. The cable tensioning device 19 preferably has a movable tension roller 20 which is spring-loaded in the direction of the drive cable 6. A change of the cable tension, for example by stretching of the drive cable 6, is thus associated with the corresponding deflection of the tension roller 20. This cable tensioning device 19 is shown by way of example in FIG. 2. Unwanted stretching of the drive cable 6 can therefore be equalized with simple means by the described cable tensioning device 19.

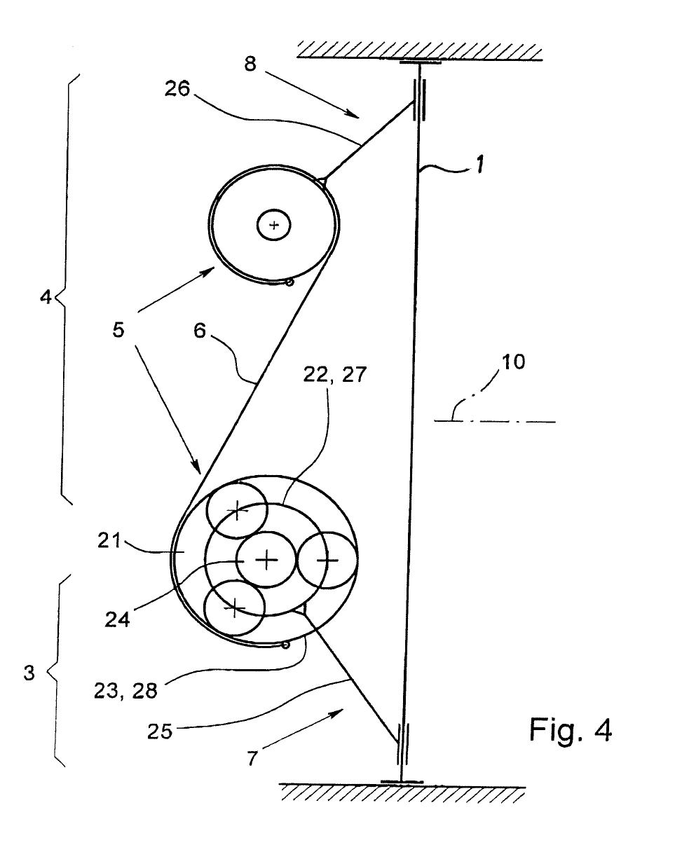

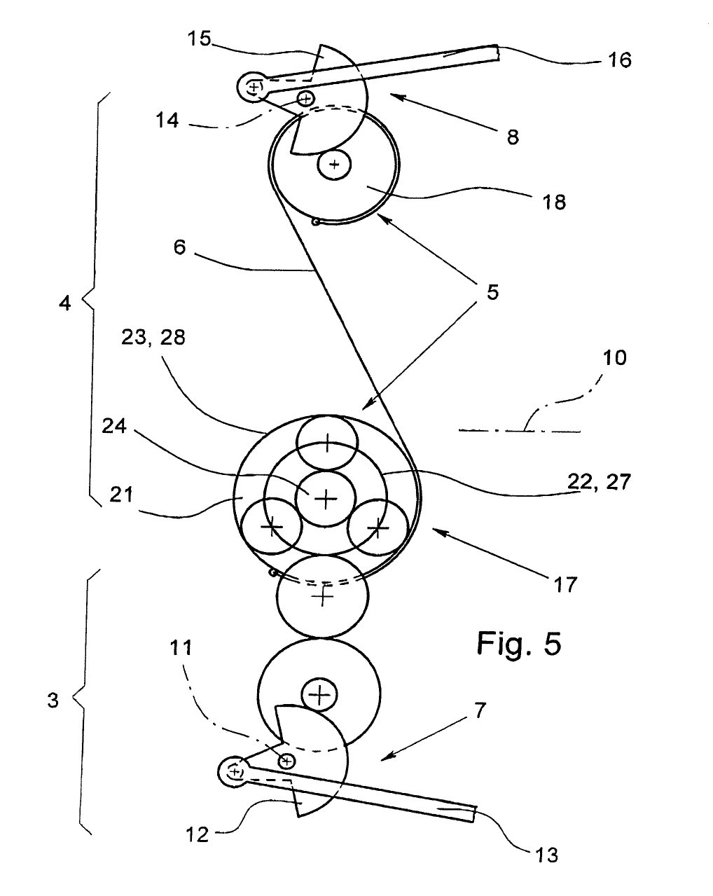

A similar effect can be achieved by the drive cable 6 having an elastic element. The elastic element can be, for example, an interposed spring or the like. 100461 Another teaching which acquires independent importance relates to a drive arrangement which is largely “resistant” to tolerances in the two drive trains 3, 4. This drive arrangement is, in terms of fundamental structure, one of the above described drive arrangements, the existence of the cable-operated speed transforming transmission 5 being immaterial to this further teaching. In this respect reference, should be made in the full scope to the aforementioned statements. In particular, all the above described versions, possibly omitting the cable-operated speed transforming transmission 5, can also be applied to the further teaching. Two preferred embodiments are shown in FIGS. 4, 5.

This drive arrangement also has a drive motor 2, which is not shown in FIGS. 4 & 5 and by which the functional element 1, as above, can be moved in two positioning directions. Furthermore, there are two drive trains 3, 4 as have, likewise, already been explained.

It is important to the further teaching that, downstream from the drive motor 2, a differential 21 with two outputs 22, 23 is connected and that the two drive trains 3, 4 proceed accordingly from the two outputs 22, 23 of the differential 21.

The aforementioned “interposition” of the differential 21 ensures a uniform distribution of the driving force to the two drive trains 3, 4, even when tolerances occur in one of the drive trains 3, 4. Possible tolerances arise, for example, by the aforementioned stretching of a drive cable 6 which may be present.

The differential 21 is made preferably as an epicyclic gear. For this purpose, a series of durable standard designs is known. One example of this is a bevel gear transmission or planetary gear. The use of a planetary gear for the drive arrangement according to the further teaching is schematically shown in FIG. 4. Here, the functional element 1 is shown only schematically as a linearly guided rod. The drive arrangement is coupled by way of drive engineering to the functional element 1 via a first drive element 25 and a second drive element 26. In this connection, the drive elements 25, 26 are each supported to be able to move linearly on the functional element 1. The first drive element 25 can be assigned to the first drive train 3 and the second drive element 26 to the second drive train 4. Thus, the two drive elements 25, 26 with their linear guides form kinematic couplings 7, 8 in the aforementioned sense.

At this point, the arrangement is such that the first drive element 25 is coupled to the output 22 of the planetary gear 21, specifically to the planet carrier 27. The second drive element 26 is coupled via a cable-operated speed transforming transmission 5 to the other output 3 of the planetary gear 21, specifically to the ring gear 28. Normally, the driving of the sun wheel 24 by the drive motor 2 causes movement of the functional element 1 in FIG. 4 to the right, against a load which is not shown. With a suitable design of the planetary gear 21, a uniform distribution of the driving force between the two drive trains 3, 4 can be achieved overall.

The aforementioned arrangement is especially advantageous in that even considerable tolerances in the two drive trains 3, 4 do not adversely affect the function of the drive arrangement, for example by a resulting twisting of the functional element 1. If for example the drive cable 6 shown in FIG. 4 were stretched, the driving of the sun wheel 24 by the driving motor 2 first of all does not cause any or only a small action of force on the first drive element 25 until the drive cable 6 has been taken up by rotation of the ring gear 28 and then applies a corresponding force to the ring gear 28. Tolerances are easily compensated by the aforementioned use of a planetary gear 21 or the like.

Numerous versions for implementation of the two drive trains 3, 4, especially of the corresponding kinematic couplings 7, 8 are conceivable. One example is, in turn, outfitting the kinematic couplings 7, 8 with a geared spindle drive. Other possibilities comprise assigning cable, chain or V-belt drives to the kinematic couplings 7, 8. In this respect, reference should be made to the prior art.

The aforementioned drive arrangement with a differential 21 is especially advantageous since, fundamentally, cable length equalization, such as, for example, the aforementioned cable tensioning device 19, can be eliminated. This leads to a considerable reduction of costs.

Especially advantageous is the fact that, with the aforementioned drive arrangement with a differential 21, also especially large-area functional elements 1 can be driven without the danger of twisting. In motorized positioning of these large-area functional elements 1, correspondingly great distances must be bridged by drive engineering; this generally leads to considerable tolerances to be expected. They are automatically equalized, as described above, by the drive arrangement in accordance with the invention.

FIG. 5 shows an embodiment of a drive arrangement with a differential 21 for motorized positioning of a hatch 1 according to FIG. 1. The structure with respect to the configuration of the kinematic couplings 7, 8 corresponds to the drive arrangement shown in FIG. 2. The first kinematic coupling 7 is coupled to the planet carrier 27 of a planetary gear 21. The second kinematic coupling 8 is coupled via a cable-operated speed transforming transmission 5 to the ring gear 28 of the planetary gear 21. As in the drive arrangement shown in FIG. 4, here, the sun wheel 24 of the planetary gear 21 is driven by a drive motor 2. Equalization of tolerances, especially when the drive cable 6 stretches, takes place, likewise, in the same manner as for the drive arrangement shown in FIG. 4.

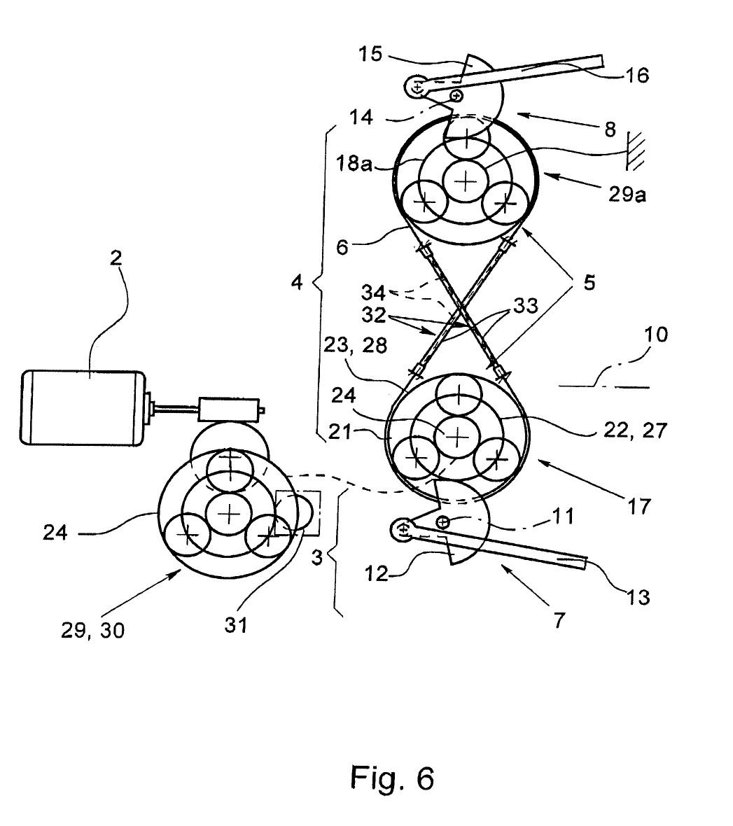

FIG. 6 shows another preferred embodiment of a drive arrangement which, in terms of its basic structure, corresponds to the drive arrangement shown in FIG. 5. Here, it is important that there is intermediate gearing 29 between the drive motor 2 and the drive trains 3, 4. The intermediate gearing 29 is made as a planetary gear here. Alternatively, there can also be a spur gear or the like. In the preferred embodiment shown in FIG. 6, the ring gear 24 of the intermediate gearing 29 is coupled to the sun wheel 24 of the differential 21. This is indicated in FIG. 6 by the identical reference numbers for the two components. The planet carrier of the intermediate gearing 29 is braked or can be braked, as is shown. Other configurations are also conceivable here.

There can also be an intermediate gearing 29 in the aforementioned sense, alternatively or additionally, in the first drive train 3 and/or in the second drive train 4. In the embodiment shown in FIG. 6, there is further intermediate gearing 29a in the second drive train 4 directly on the kinematic coupling 8. With this arrangement of the intermediate gearing 29a with a suitable design, the driving forces to be transmitted via the drive cable 6 can be made especially small. The intermediate gearing 29a is made as a planetary gear with a sun wheel which is braked. The output of the intermediate gearing 29a acting on the kinematic coupling 8 is its planet carrier. The ring gear provides the cable drum for the drive cable 6 here.

In order to ensure manual actuation, if necessary, in a further preferred configuration, a clutch 30 is connected between the drive motor 2 and the drive trains 3, 4. In the embodiment shown in FIG. 7, the clutch 30 is, at the same time, the intermediate gearing 29.

The clutch 30 can be moved into the engaged state in which the drive motor 2 is coupled by drive engineering to the drive trains 3, 4. The clutch 30 can also be moved into the disengaged state in which the drive motor 2 is separated from the drive trains 3, 4. Then, the functional element 1 can be positioned independently of the drive motor 2. If the drive motor 2 is made self-locking, it blocks the functional element 1 in the disconnected state with the clutch 30 in the engaged state. Self-locking can be implemented by the drive motor 2, as such, being made self-locking, or by other, optional, downstream gearing being made self-locking.

It is especially advantageous if the clutch 30 can be moved, in addition, into an intermediate engaged state with reduced transmission torque or with reduced transmission force. This intermediate engaged state is designed such that the functional element 1, when the clutch 30 is in the intermediate engaged state, is kept in its current position by the intended self-locking at any time, but can be positioned by manual actuation with a predetermined minimum actuating force. However, in an emergency, for example, when the voltage supply fails during motorized actuation of the functional element 1, this can be advantageous. In such an emergency, the clutch 30 would preferably drop directly into the intermediate state in which the functional element 1 is held as described above in the current position. Uncontrolled slamming of the functional element 1 which is made optionally as a hatch is thus precluded even when the voltage supply fails.

For the aforementioned function in emergency operation, the clutch 30 is designed such that, when the voltage supply fails, it drops automatically into the intermediate state and not into the disengaged state, for example, by the action of the force of a spring or a permanent magnet. The configuration of this clutch is the subject matter of European Patent Application EP 1 602 796 A2 and corresponding U.S. Patent Application Publication 2005/277512 to which the applicant refers and the contents of which are hereby made fully the subject matter of this application.

In an especially preferred configuration, the clutch 30 has a planetary gear with a planet carrier which can be braked for engagement via a brake 31. This is also explained in the above referenced application. Reference should be made expressly thereto. Of course, here there can also be braking of the sun wheel or of the ring gear.

It was explained farther above that the drive cable 6 can be made as a closed loop which loops the two cable rollers 17, 18. In this connection, it is pointed out that the drive cable 6 can also have two cable pieces which can be taken up preferably onto the two cable rolls 17, 18. With the corresponding design, the cable pieces can have the same action as the above described loop.

Fundamentally, it can be provided that the cable-operated speed transforming transmission 5 comprises simply one drive cable 6 which runs via cable rollers or the like. An especially flexible arrangement arises by the cable-operated speed transforming transmission 5 being made, at least in part, as a Bowden cable 32 with a Bowden cable jacket 33 and Bowden cable core 34 as shown in FIG. 6. Here, it is preferably provided that the Bowden cable jacket 33 has two jacket pieces. In this connection, the Bowden cable core 34 is the drive cable 6 in the aforementioned sense.

Fundamentally, it can be provided that solely traction force can be transmitted via the Bowden cable 32. This leads to a simple configuration of the Bowden cable core 34. A version is also conceivable in which that the Bowden cable 32 is made as a “push-pull” Bowden cable and that both traction force and also compression force can be transmitted via the Bowden cable 32. In this way, the above described loop-like configuration of the drive cable 6 can be omitted.

The arrangement shown in FIG. 6 enables an optimum design of the components involved in motorized positioning of the functional element 1. The drive motor 2 acts on the sun wheel of the clutch 30 made as a planetary gear. The planet carrier of the clutch 30 can be braked via the brake 31 in order to be able to move the clutch into the engaged state. The output of the clutch 30 acts directly on the sun wheel 24 of the differential 21 which is made as a planetary gear. The planet carrier 27 of the differential 21 acts without an interposed cable-operated speed transforming transmission on the kinematic coupling 7. The ring gear 28 of the differential 21 acts via the cable-operated speed transforming transmission 5 on the ring gear of the intermediate gearing 29a with a sun wheel which is braked. The planet carrier 18a of the intermediate gear 29a acts finally on the kinematic coupling 8.

In the embodiment shown in FIG. 6, it is such that the kinematic couplings 7, 8 are each coupled by drive engineering via at least one spur gear stage. These spur gear stages can optionally also be omitted.

The description above shows that numerous combination possibilities of kinematic couplings, intermediate gearing, differentials and clutches are conceivable. In order, on the one hand, to maximize design freedom, and on the other hand, to simplify production, it is provided in an especially preferred configuration that the drive arrangement can be assembled from individual modules. One module could be the kinematic coupling which would be made identical for both drive trains 3, 4. Another module would be the intermediate gearing 29, 29a or the clutch. Optionally, it is also conceivable for the intermediate gearing 29, 29a, on the one hand, and the differential 21, on the other hand, to have identical housings.

It is pointed out that all of the above described drive arrangements, including the various versions, can be applied to all conceivable functional elements 1 of a motor vehicle. Accordingly, the aforementioned functional element 1 can be a tailgate, the hood or cargo space hatch which can be positioned by a motor and the trunk lid of a motor vehicle which can be positioned by a motor. Other examples for the functional element 1 are all types of side doors which can be positioned by a motor, especially sliding doors which can be positioned by a motor. Other functional elements 1 are convertible roofs, large-area roof windows or the like which can be positioned by a motor.

Finally, it must be considered that the representations according to FIGS. 1 to 6 are not to scale. Dimensions and ratios of lengths cannot be taken from these descriptions.

What is claimed is:

1. Drive arrangement for motorized positioning of a functional element in a motor vehicle, comprising:
a drive motor by which the functional element can be moved in two positioning directions, the drive motor being coupled via a first drive train and a second drive train to the functional element and a driving force being transmitted at the same time via both drive trains during motorized movement of the functional element in at least one positioning direction, one of the two drive trains having a cable-operated speed transforming transmission with a drive cable for transmission of driving force,
wherein only one of the second drive train has said cable-operated speed transforming transmission for transmission of the driving force, the first drive train being without a cable.

2. Drive arrangement in accordance with claim 1, wherein the first drive train has a first kinematic coupling and the second drive train has a second kinematic coupling, wherein the kinematic couplings ensure coupling of the respective drive train to the functional element via drive engineering and wherein the kinematic couplings are essentially identical.

3. Drive arrangement in accordance with claim 2, wherein the drive motor is located in the immediate vicinity of the first kinematic coupling.

4. Drive arrangement in accordance with claim 3, wherein the kinematic couplings are located spaced apart from one another by a distance that is bridged, in terms of drive engineering, essentially by the cable-operated speed transforming transmission.

5. Drive arrangement in accordance with claim 1, wherein the functional element is a hatch of a motor vehicle, the hatch being coupled to the body of the motor vehicle to pivot around a hatch axis opening and closing a hatch opening in the body, the hatch being movable between an open position and a closed position by means of said drive motor.

6. Drive arrangement in accordance with claim 5, wherein the first drive train has a first kinematic coupling and the second drive train has a second kinematic coupling, wherein the kinematic couplings ensure the coupling of the respective drive train to the functional element via drive engineering, wherein the kinematic couplings are essentially symmetrically coupled to the hatch in terms of drive engineering, and wherein the kinematic couplings are located laterally so as to act on respective opposite sides of the hatch by drive engineering.

7. Drive arrangement in accordance with claim 5, wherein the first drive train has a first kinematic coupling and the second drive train has a second kinematic coupling, wherein the kinematic couplings couple the respective drive train to the functional element via drive engineering, wherein the first kinematic coupling has a first positioning element which is pivotable around a first positioning element axis and a first connecting rod, wherein the second kinematic coupling has a second positioning element is pivotable around a second positioning element axis and with a second connecting rod, wherein both connecting rods are coupled eccentrically with regard to the respective positioning element axis to the respective positioning element and to the hatch.

8. Drive arrangement in accordance with claim 1, wherein the first drive train has a first kinematic coupling and the second drive train has a second kinematic coupling, wherein the kinematic couplings couple the respective drive train to the functional element via drive engineering, wherein the first kinematic coupling has a first geared spindle drive and wherein the second kinematic coupling has a second geared spindle drive, and wherein the geared spindle drives act by drive engineering on the body of the motor vehicle and on the hatch.

9. Drive arrangement in accordance with claim 1, wherein the cable-operated speed transforming transmission has a first cable roller and a second cable roller, and wherein the drive cable coupling the two cable rollers is able to be taken up onto the cable rollers.

10. Drive arrangement in accordance with claim 9, wherein the drive cable is formed into a closed loop which loops around the cable rollers.

11. Drive arrangement in accordance with claim 5, wherein both drive trains are operative for transmitting a driving force for motorized movement of the hatch into the open position over a positioning region and wherein a driving force for motorized movement of the hatch into the closed position is transmitted over the positioning region solely via the first drive train.

12. Drive arrangement in accordance with claim 5, wherein both drive trains are operative for transmitting a driving force for motorized movement of the hatch into the closed position over a positioning region and wherein a driving force for motorized movement of the hatch into the open position is transmitted over the positioning region solely via the first drive train.

13. Drive arrangement in accordance with claim 1, further comprising an intermediate gearing in at least one of the first drive train, the second drive train and a position between the drive motor and the drive trains.

14. Drive arrangement in accordance with claim 13, wherein the intermediate gearing is a planetary gearing.

15. Drive arrangement in accordance with claim 1, further comprising a clutch connected between the drive motor and the drive trains, and wherein the clutch has a planetary gear with a sun wheel, ring gear or planet carrier which can be braked via a brake.

16. Drive arrangement in accordance with claim 1, wherein the drive cable is formed of two cable pieces a respective cable roll upon which each of cable pieces is taken up and withdrawn.

17. Drive arrangement in accordance with claim 1, wherein the cable-operated speed transforming transmission comprises, at least in part, a Bowden cable with a Bowden cable jacket and Bowden cable core.

18. Drive arrangement in accordance with claim 17, wherein the Bowden cable jacket has two jacket pieces.

19. Drive arrangement in accordance with claim 17, wherein solely traction force is transmitted via the Bowden cable

20. Drive arrangement in accordance with claim 17, wherein the Bowden cable is made as a “push-pull” Bowden cable and wherein traction and compression force are transmitted via the Bowden cable.

21. Drive arrangement in accordance with claim 1, wherein a differential with two outputs is connected downstream from the drive motor and wherein the drive trains extend from the outputs of the differential.

22. Drive arrangement in accordance with claim 20, wherein the differential comprises a planetary gear.

23. Drive arrangement for motorized positioning of a functional element in a motor vehicle, comprising:
a drive motor by which the functional element can be moved in two positioning directions, the drive motor being coupled via a first drive train and a second drive train to the functional element and a driving force being transmitted at the same time via both drive trains during motorized movement of the functional element in at least one positioning direction, one of the two drive trains having a cable-operated speed transforming transmission with a drive cable for transmission of driving force,
wherein a differential with two outputs is connected downstream from the drive motor and wherein the drive trains extend from the outputs of the differential.

24. Drive arrangement in accordance with claim 23, wherein the differential comprises a planetary gear.

25. Drive arrangement in accordance with claim 24, wherein at least one of the drive trains has a cable-operated speed transforming transmission with a drive cable for transmission of driving force and wherein a ring gear of the planetary gear forms a cable roller of the cable-operated speed transforming transmission.

26. Drive arrangement in accordance with claim 23, wherein only one of the two drive trains has a cable-operated speed transforming transmission for transmission of driving force and wherein the other drive train is a cableless drive train.

27. Drive arrangement in accordance with claim 23, wherein the functional element is a hatch of a motor vehicle, the hatch being pivotally coupled to the body of the motor vehicle to pivot around a hatch axis for opening and closing a hatch opening in the body, the hatch being movable between an open position and a closed position by means of the drive motor.

28. Drive arrangement in accordance with claim 23, wherein the first drive train has a first kinematic coupling and the second drive train has a second kinematic coupling, wherein the kinematic couplings couple a respective one of the drive trains to the functional element via drive engineering, wherein the first kinematic coupling has a first geared spindle drive and wherein the second kinematic coupling has a second geared spindle drive, and wherein the geared spindle drives act by drive engineering on body of the motor vehicle and on the other and on the hatch.
